(19) United States
(12) Patent Application Publication
(10) Pub. No.: US 2009/0261102 A1
(43) Pub. Date: Oct. 22, 2009

(54) Cover for Cooking Vessel

(76) Inventor: Kay E. Sparks, Cardington, OH (US)

Correspondence Address: JAY M. SCHLOFF, 6960 Orchard Lake Road, Suite 315, West Bloomfield, MI, 48322, US

(21) Appl. No.: 12/107,260

(22) Filed: Apr. 22, 2008

(51) Int. Cl. B65D 51/16; A47J 27/00

(52) U.S. Cl. 220/372; 220/573.1; 220/731

(57) ABSTRACT

Disclosed is a cover for a cooking vessel. The cover includes a screen having a dome-shaped structure and a frame coupled to a peripheral edge of the screen. The frame is adapted to be received on a top portion of the cooking vessel, thereby disposing the cover on the cooking vessel. Also disclosed is a cover for cooking vessels, which is adapted to be disposed on a top portion of cooking vessels of various sizes. The cover includes a first portion and a second portion slidably coupled to the first portion. The first portion includes a first screen, a first frame coupled to a bottom peripheral edge of the first screen, and a retracting mechanism configured on the first frame. The second portion includes a second screen, and a second frame coupled to a bottom peripheral edge of the second screen.

### FIELD OF THE INVENTION

The present invention relates generally to a kitchen article, and, more particularly, to a cover for a cooking vessel which avoids splattering of food while preparing the food in the cooking vessel.

### BACKGROUND OF THE INVENTION

For ages people have used cooking vessels for preparation of various food articles. Generally, some of the food articles would be required to be prepared in hot oil, due to which preparation particles from the food article (hereinafter referred to as “food particles”) and the oil itself could be splattered on the surrounding cooking area such as a stovetop or conventional oven. In such a case, the splattered food particles and oil needs to be cleaned for keeping the cooking area clean and hygienic.

In recent times, people have turned to using microwave ovens for preparing food. The problem of splattering of food particles is also associated with microwave oven. As a result, the food particles may be splattered on inner walls of the microwave oven. The splattered food particles stick to the inner walls, thereby requiring frequent cleaning of the microwave oven, which is a time consuming and a cumbersome process.

Accordingly, there exists a need for a cover which is adapted to be disposed on a top portion of cooking vessels being used for preparing a food article, such that the cover avoids splattering of food particles while the food article is being prepared.

### SUMMARY OF THE INVENTION

In view of foregoing disadvantage inherent in the prior art, the general purpose of the present invention is to provide a cover for a cooking vessel, to include all the advantages of the prior art, and overcome the drawbacks inherent therein.

Accordingly, an object of the present invention is to provide a cover for a cooking vessel, which is adapted to be disposed on a top portion of the cooking vessel and which avoids splattering of food particles while preparing a food article in the cooking vessel.

In light of the above object, in one aspect of the present invention, a cover for a cooking vessel is disclosed. The cover includes a screen having a dome-shaped structure and a frame coupled to a peripheral edge of the screen. The frame is adapted to be received on a top portion of the cooking vessel, thereby disposing the cover on the cooking vessel.

In another aspect of the present invention, a cover for cooking vessels is disclosed, such that the cover is adapted to be disposed on a top portion of cooking vessels of various sizes. The cover includes a first portion and a second portion. The first portion includes a first screen having a semi dome-shaped structure, a first frame coupled to a bottom peripheral edge of the first screen, and a retracting mechanism configured on the first frame of the first screen. The second portion includes a second screen having a semi dome-shaped structure, and a second frame coupled to a bottom peripheral edge of the second screen. The second frame is adapted to be slidably coupled to the retracting mechanism of the first portion. The slidable coupling between the second frame and the retracting mechanism enables a slidable movement between the first portion and the second portion. Moreover, the first frame and the second frame are adapted to be received on a top portion of the cooking vessel, thereby disposing the cover on the cooking vessel.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates a perspective view of a cover for a cooking vessel, in accordance with an exemplary embodiment of the present invention;

FIG. 2 illustrates a perspective view of the cover being utilized on a cooking vessel, in accordance with an exemplary embodiment of the present invention; and

FIG. 3 illustrates a perspective view of a cover for a cooking vessel, in accordance with another exemplary embodiment of the present invention.

Like reference numerals refer to like parts throughout the description of several views of the drawings.

### DETAILED DESCRIPTION OF THE INVENTION

The exemplary embodiments described herein detail for illustrative purposes and are subject to many variations in structure and design. It should be emphasized, however, that the present invention is not limited to a particular cover for a cooking vessel, as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present invention provides a cover for a cooking vessel. The cover is adapted to be disposed on a top of the cooking vessel, such that the cover avoids splattering of food particles while preparing a food article in the cooking vessel, especially in a microwave oven. The present invention also provides a cover for a cooking vessel, which is adapted to be disposed on cooking vessels of various sizes.

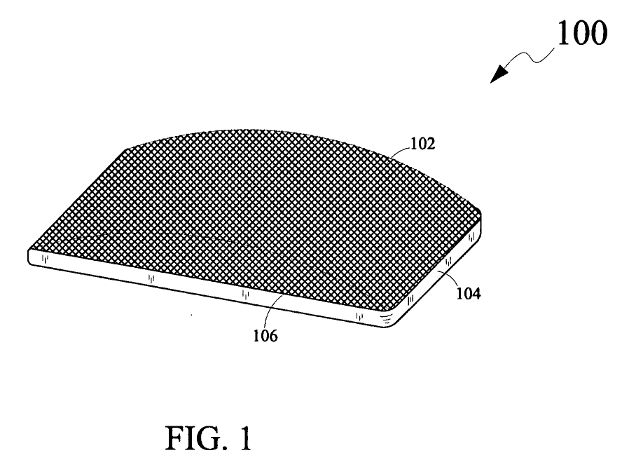

Referring to FIG. 1, a perspective view of a cover 100 for a cooking vessel, in accordance with an exemplary embodiment of the present invention, is illustrated. The cover 100 includes a screen 102 and a frame 104. The frame 104 is coupled to a peripheral edge 106 of the screen 102.

In one embodiment of the present invention, the cover 100 is configured as a rectangular dome-shaped structure. More specifically, the screen 102 has a dome-shaped structure with the peripheral edge 106 of the screen 102 defining a rectangular-shape. Accordingly, the frame 104 coupled to the peripheral edge 106 of the screen 102 is also configured to have a rectangular-shaped structure. The frame 104 is adapted to avoid bending of the screen 102, thereby providing strength to the cover 100.

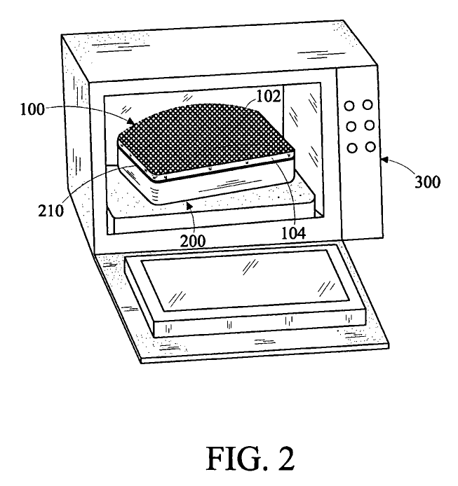

Moreover, the cover 100 is adapted to be disposed on a top portion of a cooking vessel. More specifically, the frame 104 of the cover 100 is adapted to be received on the top portion of the cooking vessel, thereby disposing the cover 100 thereon. The use of the cover 100 for covering a cooking vessel may be explained in conjunction with FIG. 2.

FIG. 2 illustrates a perspective view of the cover 100 in a utilized state, in accordance with an exemplary embodiment of the present invention. The term “utilized state” of the cover 100 used herein refers to a state of the cover 100 when it is disposed on a top of a cooking vessel. As shown in FIG. 2, the cover 100 is disposed on a cooking vessel 200. More specifically, the cover 100 is disposed on a top portion 210 of the cooking vessel 200. Moreover, the cooking vessel 200 is placed inside a microwave oven 300 for preparing a food article therein. The cover 100 avoids food particles, from being splattered to the surrounding areas of the cooking vessel 200, and more specifically, to inner walls of the microwave oven 300.

Without limiting the scope of the present invention, in one embodiment the screen 102 of the cover 100 is a wire-mesh, having a plurality of closely spaced openings. Hereinafter, the plurality of closely spaced openings is referred to as “openings”. Upon disposing the cover 100 on the cooking vessel 200, while preparing a food article therein, the openings in the screen 102 of the cover 100 enable steam produced during the preparation of the food article to escape from the cooking vessel 200. Accordingly, the wire mesh avoids creation of an excess pressure within the cooking vessel 200. However, the openings in the wire mesh are configured in a manner such that the openings are capable of avoiding the food particles to pass therethrough, thereby avoiding splattering of the food particles outside the cooking vessel. In one embodiment of the present invention, the wire mesh may be made from a heat resistant material, such as stainless steel. Other heat resistant materials that may be used to make the wire mesh include, but are not limited to, steel, aluminum, copper, and nickel.

Moreover, the frame 104 of the cover 100 is composed of a heat resistant material. Accordingly, the screen 102 and frame 104 are capable of enduring high temperatures encountered while preparation of the food article in the cooking vessel. Further, it will be apparent to a person skilled in the art that the cover 100 may be configured to have any other shape, apart from the rectangular shape, for adapting to cooking vessels of different shapes. For example, the cover 100 may be configured to have a circular dome-shaped structure or any other polygonal dome-shaped structure, such that the cover 100 may be disposed on cooking vessels having a circular structure or a polygonal structure, respectively. In one embodiment of the present invention, the frame 104 may be made from a heat resistant material, such as stainless steel. Other heat resistant materials that may be used to make the frame 104 include, but are not limited to, aluminum, copper, cast iron, stainless steel, carbon steel, glass, ceramic, and silicone, and any other material known in the art that is safe to subject to the heat, pressure, and water associated with a dishwasher appliance.

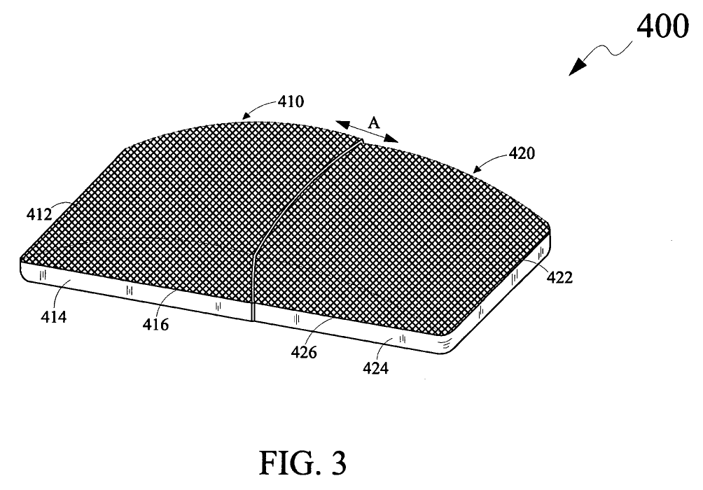

The present invention further provides a cover which is adapted to be disposed on cooking vessels of various sizes. More specifically, the cover is adapted to be disposed on different cooking vessels having differently sized top portions, such as the top portion 210 of the cooking vessel 200. Referring to FIG. 3, illustrated is a perspective view of a cover 400 which is adapted to be disposed on different cooking vessels, in accordance with another exemplary embodiment of the present invention. The cover 400 includes a first portion 410 and a second portion 420. The first portion 410 and the second portion 420 are slidably coupled.

The first portion 410 includes a first screen 412, a first frame 414 and a retracting mechanism (not shown). In one embodiment of the present invention, the first portion 410 may be configured to have a semi dome-shaped structure. More specifically, the first screen 412 of the first portion 410 may be configured to have the semi dome-shaped structure with the first frame 414 coupled to a bottom peripheral edge 416 of the first screen 412. The retracting mechanism is configured on the first frame 414. Moreover, the retracting mechanism is adapted to slidably couple the first portion 410 and the second portion 420.

The second portion 420 includes a second screen 422 configured to have a semi dome-shaped structure, and a second frame 424 coupled to a bottom peripheral edge 426 of the second screen 422. Moreover, the second frame 424 is slidably coupled to the retracting mechanism of the first portion 410. More specifically, the slidable coupling between the second frame 422 and the retracting mechanism of the first portion 410 enables a slidable movement between the first portion 410 and the second portion 420. Furthermore, the semi dome-shaped structure of the second portion 420 is configured to have a smaller size than the semi dome-shaped structure of the first portion 410. Accordingly, the second portion 420 is adapted to be moved in or out of the first portion 410 upon slidable movement between the first portion 410 and the second portion 420. The direction of slidable movement of the second portion 420 with respect to the first portion 410 is indicated by an arrow ‘A’ in FIG. 3.

In use, the slidable movement between the first portion 410 and the second portion 420 enables the cover 400 to be adjusted to suit the different cooking vessels having differently sized top portions. More specifically, the slidable movement between the first portion 410 and the second portion 420 enables in adjusting a size of the cover 400, such that the cover 400 is capable of accommodating the cooking vessels of various sizes. Thereafter, the first frame 414 and the second frame 424 may be received on a top portion, such as the top portion 210, of a cooking vessel, such as the cooking vessel 200, for disposing the cover 400 thereon.

Without limiting the scope of the invention, the first portion 410 and the second portion 420 of the cover 400 are composed of a heat resistant material. More specifically, the first screen 412, the first frame 414, the second screen 422 and the second frame 424 are composed of a heat resistant material such as, but not limited to, nylon. The use of heat resistant materials enable the cover 400 to endure high temperatures encountered during preparation of food articles within the cooking vessel. Moreover, in one embodiment of the present invention, the first screen 412 and the second screen 422 are a wire-mesh, such as the wire-mesh explained in conjunction with FIGS. 1 and 2. The first frame 414 and second frame 424 may be made any suitable and formable heat resistant material, including but not limited to, vinyl, aluminum, and nylon.

Furthermore, in one embodiment of the present invention, the cover 400 may be configured to have a rectangular dome-shaped structure, as shown in FIG. 3. However, it will be apparent to a person skilled in the art that the cover 400 may be configured to have other shapes also, such as a circular dome-shaped structure or any polygonal dome-shaped structure.

In an exemplary embodiment, the cover 100 may have a length of about 14 inches (in) and a width of about 10 in. In another exemplary embodiment of the present invention, the cover 100 may be configured to have a length of about 9 in and a width of about 9 in. In yet another exemplary embodiment of the present invention, the cover 400 may have a length of about 15 in and a width of about 10 in. More specifically, the first portion 410 may have a length of about 9 in and a width of about 10 in and the second portion 420 may have a length of about 6 in and a width of about 10 in.

The cover for cooking vessels, as described herein, may be conveniently utilized for covering the cooking vessels while preparing a food article therein, thereby avoiding splattering of food articles from the cooking vessel. Moreover, the cover is adapted to be adjustable in size for covering cooking vessels of differently sized top portions. Furthermore, the cover is easily washable and hence may be reused. Additionally, the cover may be used during outdoor picnics for covering food articles contained in a vessel, such that the food articles are protected from insects.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but these are intended to cover the application or implementation without departing from the spirit or scope of the claims of the present invention.

What is claimed is:

1. A cover for a cooking vessel, the cover comprising:
a screen having a dome-shaped structure; and
a frame coupled to a peripheral edge of the screen,
wherein the frame is adapted to be received on a top portion of the cooking vessel, thereby disposing the cover on the cooking vessel.

2. The cover of claim 1, wherein the screen is composed of a heat resistant material.

3. The cover of claim 1, wherein the frame is composed of a heat resistant material.

4. The cover of claim 1, wherein the screen is a wire-mesh.

5. A cover for a cooking vessel, the cover comprising:
a first portion comprising
a first screen having a semi dome-shaped structure,
a first frame coupled to a bottom peripheral edge of the first screen, and
a retracting mechanism configured on the first frame of the first screen; and
a second portion comprising
a second screen having a semi dome-shaped structure, and
a second frame coupled to a bottom peripheral edge of the second screen,
wherein the second frame is adapted to be slidably coupled to the retracting mechanism of the first portion, and,
wherein the slidable coupling between the second frame and the retracting mechanism enables a slidable movement between the first portion and the second portion, and,
wherein the first frame and the second frame are adapted to be received on a top portion of the cooking vessel for disposing the cover on the cooking vessel.

6. The cover of claim 5, wherein the first screen is composed of a heat resistant material.

7. The cover of claim 5, wherein the second screen is composed of a heat resistant material.

8. The cover of claim 5, wherein the first frame is composed of a heat resistant material.

9. The cover of claim 5, wherein the second frame is composed of a heat resistant material.

10. The cover of the claim 5, wherein the first screen is a wire-mesh.

11. The cover of the claim 5, wherein the second screen is a wire-mesh.
